(19) United States
(12) Patent Application Publication
(10) Pub. No.: US 2003/0040279 A1
(43) Pub. Date: Feb. 27, 2003

(54) Wireless thermostat system

(76) Inventor: Alan R. Ballweg, Boca Raton, FL (US)

Correspondence Address: JOHN C. SMITH, ESQ., 4800 NORTH FEDERAL HIGHWAY, SUITE A-207, BOCA RATON, FL, 33431, US

(21) Appl. No.: 10/217,655

(22) Filed: Aug. 13, 2002

Related U.S. Application Data
(60) Provisional application No. 60/314,057, filed on Aug. 22, 2001.

(51) Int. Cl. H04B 7/00

(52) U.S. Cl. 455/66; 455/74

(57) ABSTRACT

An apparatus and method of binding serial numbers to thermostats to ensure that every thermostat in a large facility has a unique identification number. A Multi-Frequency Spread Spectrum technique (MFSS/AR) is used to select the suitable frequency for communication between remote thermostats and a centrally located controller. The MFSS/AR technique also uses an Acknowledgment/Retry procedure to ensure that each transmission is correctly received. In addition to reducing interference from other thermostats, the frequency switching used by the MFSS/AR technique also reduces the effects of background noise levels by selecting a clear frequency channel for a thermostat in a particular physical location.

### CROSS-REFERENCE TO RELATED APPLICATIONS

This application is a non-provisional application which claims the benefit of the commonly owned copending application entitled “Wireless Sensor System,” filed Aug. 22, 2001, bearing U.S. Ser. No. 60/314,057 and naming Alan R. Ballweg, the named inventor herein, as sole inventor, the contents of which is specifically incorporated by reference herein in its entirety.

### BACKGROUND OF THE INVENTION

1. Technical Field

The present invention relates to sensing systems. In particular, it relates to wireless sensor systems which allow multiple wireless sensing devices to be used in close proximity to one another through the use of address binding, multi-frequency spread spectrum frequency hopping techniques, and background noise level monitoring to determine optimal positioning of the sensor. The sensing devices can be used for a variety of purposes, such as thermostats, humidity control devices, security devices, fire alarms, etc.

2. Background Art

Sensors are widely used in a variety of applications. For example, in commercial buildings, temperature sensing is vital to providing a usable work area. In a typical commercial building, numerous temperature sensors (i.e. thermostats) are typically located at various points within the building. The thermostats are usually hardwired in the building walls when the building is constructed. While hardwiring during the construction process is relatively easy to do, relocating the thermostats as changes are made to office configurations can be require significantly more work, and as a result, the changes can be significantly more costly and inconvenient. Further, in a typical commercial environment, it is often necessary to reposition and re-wire thermostats on a regular basis due to changes in a tenant's requirements. As a result, building operators have an ongoing expense related to installation and removal of thermostats in a commercial environment caused by changes in office configurations. It would be desirable to have an inexpensive and convenient way of installing or moving sensors after the initial installation.

In addition to the substantial cost of changing wiring after a building is complete, the cost of initially installing the wiring is also expensive. This is due to the high cost created by building codes, labor rates, etc. It would be desirable to have an inexpensive and convenient way to install sensors in a building during the initial construction phase, which does not require the cost and labor which results from hardwiring a building.

The foregoing discussion used thermostats as an example of a typical sensor device in a building. Those skilled in the art will recognize that a variety of other sensor types are used in commercial building environments which have entirely different purposes. For example, humidity sensors can also be used to control humidity within a building. The humidity sensors can be used in combination with thermostats to provide the optimnum comfort level with the lowest utility cost. Likewise, security devices, such as fire sensors, broken glass sensors, infrared intruder sensors, can also be in widespread use within a commercial building. In addition, corporations frequently have internal security systems, such as a badge readers or keypad access entry devices, to control and monitor access to their facilities by their employees. All of these sensor systems have the same problems discussed above in regard to thermostats. In particular, they must all be hardwired which results in substantial installation expense as well as substantial expense when changes need to be made. It would be desirable to have a method of installing a variety of sensing devices which would not require substantial wiring during the building construction stage or as a result of changes in the building configuration after construction was complete.

For ease of discussion, thermostats will be used throughout this disclosure to illustrate the benefits and advantages of the invention. However, it is understood that while thermostats are used to describe the invention, the invention can be used with any type of sensor device, such as those listed and discussed above, including but not limited to humidity sensors, fire alarms, security devices, glass break detectors, burglar alarms, gas sensors (e.g. carbon monoxide, etc.), pressure sensors, etc.

Recognizing the disadvantages of having to install wiring between remotely located thermostats and a central heating and/or air conditioning unit, the prior art has produced wireless thermostats. The wireless nature of these thermostats allow them to be easily placed in various locations in a building after it has been completed. For the purpose of this discussion, the term “sensor” is intended to refer to any device which gathers and transmits data from within a building, and includes, but is not limited to, the foregoing examples.

Existing wireless sensors, while solving some problems encountered by hardwired sensors, also have some drawbacks. For example, in a large building that has many sensors, there are problems related to interference between the sensors as well as problems related to distance between the sensor and related equipment. For example, the distance between air conditioning and/or heating units and a remotely located thermostat may raise issues related to the level of transmission power required to properly communicate. It would be desirable to have an air conditioning and/or heating unit which could communicate with a large number of wireless thermostats without interference between the thermostats, and which could communicate with thermostats located a substantial distance from the air conditioning and/or heating unit. Of course, it would be desirable to have the ability to communicate between any type of sensor and its related equipment.

In addition to the problems generated by interference between thermostats, a wireless thermostat is also susceptible to performance degradation from interference generated by other sources. It would be desirable to be able to avoid environmental interference when using wireless thermostat devices.

While addressing the basic desirability of using wireless thermostats, the prior art has failed to provide a remotely located wireless thermostat which is able to communicate over substantial distances with an air conditioning and/or heating unit, which can communicate without interference from other wireless thermostats, and which can communicate with a minimum amount of interference from other environmental factors.

### SUMMARY OF THE INVENTION

The present invention solves the foregoing problems by providing an apparatus and method of binding serial numbers to thermostats to ensure that every thermostat in a large facility has a uniqiie identification number. A Multi-Frequency Spread Spectrum technique (MFSS/AR) is used to select the suitable frequency for communication between remote thermostats and a centrally located controller. The MFSS/AR technique uses an Acknowledgement/Retry procedure to ensure that each transmission is correctly received. In addition to reducing interference from other thermostats, the frequency switching used by the MFSS/AR technique also reduces the effects of background noise levels by selecting a clear frequency channel for a thermostat in a particular physical location.

### BRIEF DESCRIPTION OF THE DRAWINGS

FIG. 1 is a diagram of a preferred embodiment of the invention which illustrates a number of remote sensors (e.g. wireless thermostats, etc.), connected to a base transceiver, hereinafter “TEC,” which in turn is connected to air conditioning and/or heating units.

FIG. 2 is a diagram illustrating the use of a portable computer to access a Remote sensor for the purpose of setting the binding address.

FIG. 3 is a flow chart that illustrates a preferred embodiment of the binding process.

### DESCRIPTION OF THE PREFERRED EMBODIMENT

Prior to a detailed description of the figures, a general overview of the features and advantages of the system will be presented. This invention can be implemented with any type of commercial building sensor, including temperature sensors, humidity sensors, fire sensors, smoke sensors, burglary (i.e. “intruder”) sensors, broken glass sensors, etc. In addition, it can also be used in conjunction with access control devices, such as badge readers, keypad entry controllers, etc. For ease of discussion, the invention will be discussed in terms of a wireless room temperature control solution for use in commercial/industrial buildings as a cost-competitive alternative to wired thermostats. However, this wireless sensing and control invention can be used in a wide variety of applications, such as those listed above. In addition, it is also possible to implement this invention in smaller physical environments, such as residential housing, etc.

There are two primary elements of the invention. First, the thermostat includes a remote sensor. The remote sensor measures the temperature using known techniques in the same manner as conventional thermostats measure temperature. The remote sensor also communicates with a base transceiver which communicates with the air conditioner and/or heating unit. In the preferred embodiment, the remote sensor and base transceiver are programmable devices which allows their functions to be upgraded or modified as needed.

The remote sensor and the base transceiver communicate using an MFSS/AR technique. MFSS/AR means “Multi-Frequency Spread Spectrum with Acknowledgement and Retries.” The MFSS/AR technique is an extremely robust and reliable way to ensure communications while maximizing battery life, and also allows hundreds of units to coexist in the same area without interfering with each other. Two elements are involved: the remote sensor and the base transceiver, both of which are radio transceivers with 20 channels. Those skilled in the art will recognize that while the preferred embodiment uses 20 channels, each having a different frequency, the number of channels is not critical and any suitable number of communication channels can be used.

The remote sensor which embodies this invention has three basic modes. In normal operation, MFSS/AR runs in “normal mode,” which is the mode the system will typically use for 99.9% of its life. In Normal Mode, the remote sensor transmits temperature and other data every periodically (in the preferred embodiment: sixty seconds). Each transmission is acknowledged by the base transceiver. Preferably, the remote sensor is battery powered, while the base transceiver is line powered.

In “transparent mode,” a laptop computer (or other suitable device) can be connected to the remote sensor to allow it to communicate with the base transceiver wirelessly using software in the laptop computer.

The third mode is “demo mode” in which the remote sensor transmits data every four seconds, and the data can be viewed on the laptop connected to the base transceiver. In this mode, the remote sensor can use displays, such as LEDs, to indicate the radio signal strength to permit easy evaluation of the best possible physical location for the remote sensor during installation. In the preferred embodiment, the LEDs are illuminated on four second intervals as follows: zero blinks indicates poor or no reception, one blink indicates acceptable reception, two blinks indicates good reception, and three blinks indicates excellent reception.

Prior to initial use, the user sets a “binding address” in both the remote sensor and base transceiver. In the preferred embodiment, this is accomplished using a PC via a serial link. However, any suitable method of setting the binding address can be used, such as manually operated switches, radio communication, infrared communications, etc. The binding address is a unique address associated with one particular remote sensor. In the preferred embodiment, the binding numbering system is designed to ensure a unique address for all units at a site. In addition, binding address is stored in an EEPROM so that it will not be lost if power is lost. As a result, in a large commercial building having numerous wireless thermostats, each wireless thermostat will have a unique address to identify it to the base transceiver. In addition, the binding address allows adjoining buildings to use the same system without interference between one another.

The base transceiver will initially be in “resynchronization mode,” in which it rapidly scans a portion of the twenty available channels. In the preferred embodiment, the base transceiver scans only four of the channels. However, those skilled in the art will recognize that the number of scanned channels can be varied. The base transceiver continuously scans the channels until it detects a transmission from a remote sensor with a valid binding address. All such transmissions are acknowledged.

The remote sensor will attempt to communicate with a base transceiver on channel 1. It sends its binding address with every communications attempt. If it does not receive an acknowledgment from the base transceiver, it will try to re-contact the base transceiver, as discussed more fully below. Once communication is established, the remote sensor and base transceiver will continue using that channel, transmitting temperature data once each minute. This will continue until radio interference is encountered.

If interference is encountered, the remote sensor will try the current frequency channel three times, then wait 1 minute and try again three more times. If communication cannot be established, it will assume the channel is no longer usable, and will jump to the next frequency and try again, three times. The allowable frequencies are stored in a hopping table. To save energy, it will attempt to communicate on a maximum of 3 channels each minute. Of course, those skilled in the art will recognize that the number of retries can vary, as well as the next selected frequency which does not have to be the next one in the hopping table. In a preferred embodiment, the amount of time between retries for each remote sensor is varied. This provides an additional advantage in that if two remote sensors are attempting to communicate on the same frequency at the same time, when they retry there will be no data collision because one remote sensor will contact the base transceiver before the other remote sensor will.

Meanwhile, the base transceiver will know that it has not received an expected communication, and will also assume the channel is no longer useable. It will start resynchronization mode, rapidly scanning all channels, until it receives communications from the remote sensor.

The MFSS/AR technique provides several benefits. First, hundreds of wireless thermostats can coexist in the same area without “stepping” on each other, since they are simultaneously using different ID numbers, different frequencies, and different time slots. (FDMA and TDMA).

Second, it is very low power. Since the communication cycle is extremely brief and the cycle is only initiated once a minute, the wireless thermostat can be put into sleep mode during periods of non-activity. This will greatly increase battery life in the wireless thermostat.

Third, communications are extremely reliable, because the system is virtually guaranteed to get the message through unless interference is simultaneously and continuously present on all 20 channels. The system will “naturally” tend to gravitate to the channels which experience the least interference.

If communications is disrupted or power is lost, the system will fall back to a “safe” state and follow a procedure to reestablish communications. This is facilitated through the use of the binding number which is stored in an EEPROM that insulates it from power failure.

Another problem associated with wireless thermostats is that in addition to the normal transmission problems which may occur between two remote devices, the remotely located thermostats are also subject to interference from unrelated devices or equipment. This interference from unrelated devices or even nearby wireless thermostats can be minimized by locating the wireless thermostat in a location which has minimal interference. The preferred embodiment of the wireless thermostat taught herein reduces problems caused by interference by providing a method of locating the wireless thermostat in an area of a room with the minimum level of interference.

This is done by measuring and outputting both “RSSI” (Received Signal Strength Indicator) which is a standard radio receiver measurement, and “BSSI” (Background Signal Strength Indicator). RSSI, Received Signal Strength Indicator is measured during actual radio reception and indicates the strength of the signal as it is received. It is displayed in dBm and the higher (less negative) the number is, the greater the signal strength. A value greater than −90 is an acceptable signal, greater than −70 is a strong signal. Every 3 dBm gain means a doubling of actual signal strength, eg: a 9 dBm increase means 2×2×2=8 times greater signal strength. BSSI is an indication of the background radio frequency noise in the local area. BSSI can be used to help evaluate a potential site for excessive radio interference. In the preferred embodiment, the BSSI number is also in dBm (decibels referenced to a milliwatt) and the higher (less negative) the number the greater the background noise. A value greater than −100 indicates significant background noise. When used in combination, RSSI and BSSI measurements can be used to determine the location within a room that has the most desirable combination of RSSI and BSSI, where RSSI preferably has a large value and BSSI preferably has a low value. An advantageous feature of the invention is that by using both the RSSI and the BSSI values in combination, installation of the remote sensor can be made more accurately than would be possible by only using the RSSI value.

Those skilled in the art will recognize that when using the RSSI and BSSI values, the RSSI and BSSI data can be collected together or can be collected separately. In addition, the base transceiver can determine a combined value for the RSSI and BSSI values which indicates the best location for the remote sensor, or the combined value can be done remotely in the remote sensor.

In the preferred embodiment, when the wireless thermostat is being installed, it communicates its RSSI via a blinking LED, allowing an installation technician to quickly get a feel for the best location for the wireless thermostat. For example, 0-3 LED blinks indicate poor to excellent RSSI. Likewise, the BSS can be determined in the same manner. This allows an installation technician to determine the best location within a given room by merely walking about the room while holding the wireless thermostat.

In “normal mode” the preferred embodiment of the wireless thermostat transmits the following data via radio transmission: current temperature, temperature setpoint, day/night override status. Those skilled in the art will recognize that in addition to the foregoing data, the wireless thermostat can also transmit a variety of other environmental data. The system also permits long-term site monitoring by automatically outputting temperature, RSSI, and BSSI each minute. We turn now to a detailed discussion of the figures.

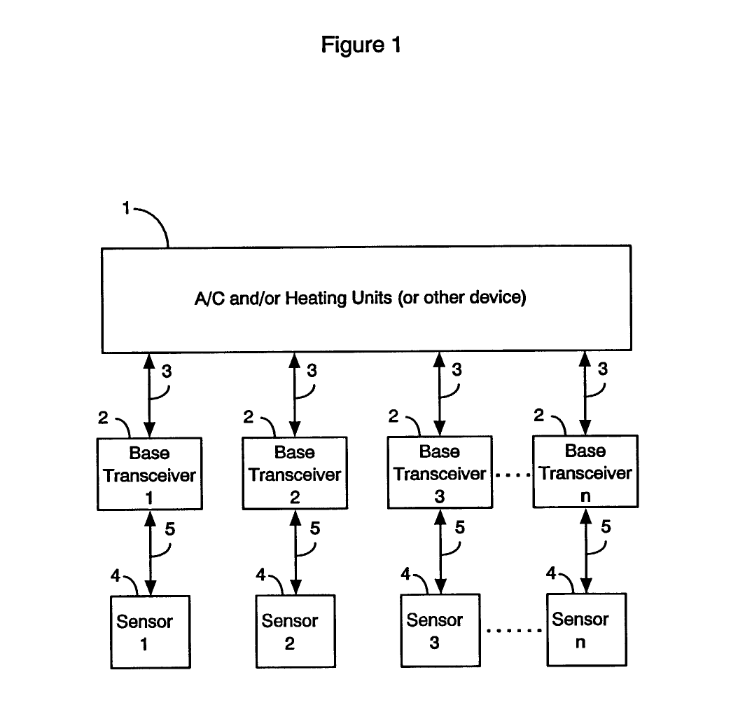

Referring to FIG. 1, this figure shows a preferred embodiment of the invention in which a plurality of remote sensor units 4 (e.g., wireless thermostats) communicate with a base transceiver 2 which in turn provides information to an air conditioning and/or heating unit 1. The air conditioning and/or heating unit 1 may be any one of a number of commercially available air conditioning and/or heating units. The base transceiver 2 would preferably communicate with the air conditioning and/or heating unit 1 via hardwired cable 3.

Each remote sensor 4 independently communicates with the base transceiver 2 via wireless transmission links 5. In the preferred embodiment, the wireless transmission links 5 have 20 separate frequency channels available. As will be described more fully below, the base transceiver 2 and the remote sensor 4 will scan frequency channels to select the frequency channel which has acceptable transmission quality. Each remote sensor 4 also has a unique binding address which is used to identify it to the base transceiver 2. These and other features will be described more fully in the following figures.

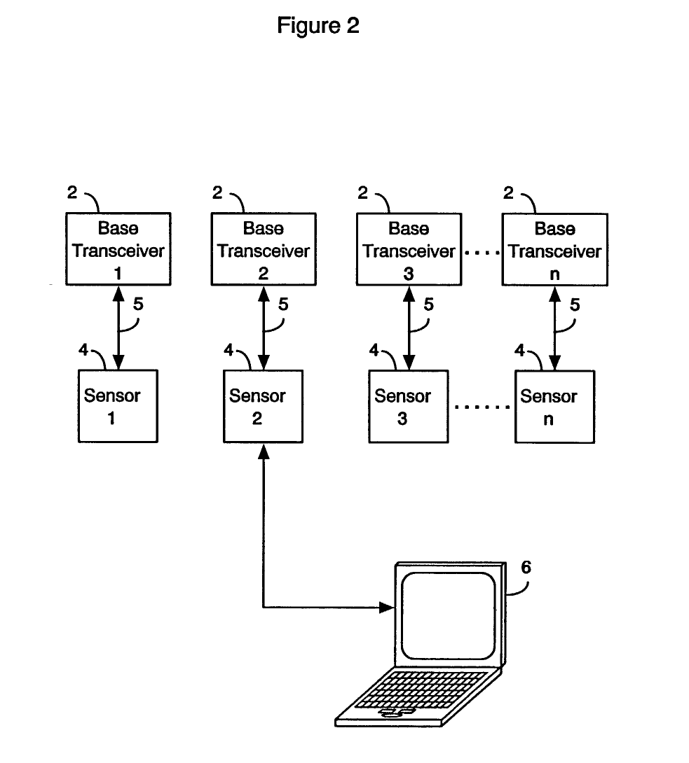

Regarding FIG. 2, this figure illustrates a preferred embodiment of the invention in which an individual remote sensor 4 is attached to the base transceiver 2 as discussed above. In addition, the laptop computer 6 is connected to a remote sensor 4 via a serial cable 7. The laptop computer 6 is used to program an EEPROM chip (not shown in this figure) with a unique binding address which will be used to identify that particular remote sensor 4 to the base transceiver 2. Once the binding address is established, the remote sensor 4 will use the binding address to identify itself to the base transceiver 2 when it communicates with the base transceiver 2. The base transceiver 2 then adds the binding address to its list of valid binding addresses. During this programming procedure, additional information such as the location of the remote sensor 4 can be supplied to the base transceiver 2.

Those skilled in the art will recognize that a variety of techniques can be used to establish the binding address and control the programming process. For example, the function of the serial cable 7 can be replaced with other communication technologies, such as infrared, radio, etc. Likewise, while the laptop computer 6 is preferred because it is relatively inexpensive and can be used for a variety of other purposes, it can also be replaced with alternative devices, such as a commercially available PDA (personal digital assistant), or even a limited function device specifically created for this single purpose. In fact, this function can even be incorporated into the base transceiver 2 which can be attached to a remote sensor in the same manner as was done with the personal computer 6, and the base transceiver 2 would then be capable of initializing a remote sensor 4 with a unique binding address.

Those skilled in the art will recognize that while any suitable method may be used to create a valid binding address, the important feature of the invention is that, once the binding process is complete, a unique and valid binding address for each remote sensor 4 exists which the base transceiver 2 can use to identify each remote sensor 4 during normal communications.

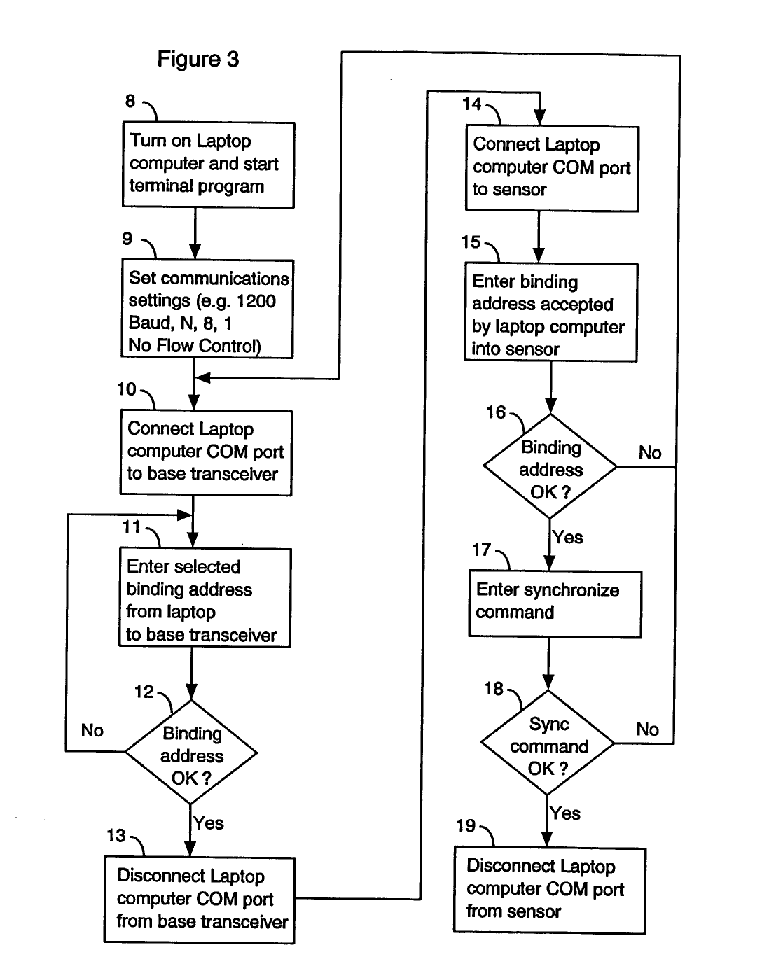

FIG. 3 is a flow chart which illustrates a preferred embodiment of the binding process. The binding process begins when the user, at step 8, turns on the laptop computer 6 and activates the software to emulate a terminal. Terminal software is well-known in the art. At step 9, the appropriate communications parameters are set. In the preferred embodiment, typical modem settings of “1200 baud, N, 8, 1, No Flow Control” are used. These settings are commonly used and are well-known in the art. Those skilled in the art will recognize that any suitable alternative communications protocol can be used, and will also recognize that the aforementioned protocol is exemplary of one possible design out of many.

The next step is to connect the laptop computer 6 COM port to the base transceiver 2. This would be accomplished by connecting the COM port to an RJ11 jack on the base transceiver 2. This is illustrated at step 10. At this point the laptop computer 6 is connected to the base transceiver 2. In step 11, the user enters a tentative binding address into the laptop computer 6 which inputs it to the base transceiver 2 for approval by the base transceiver 2. If the tentative binding address is not excepted by the base transceiver 2 at step 12, then the user returns to step 11 to try another binding address. On the other hand, if the binding address is acceptable, the user can then disconnect the laptop computer 6 from the base transceiver 2, at step 13.

At step 14, the user then proceeds to connect the laptop computer 6 COM port to the remote sensor 4 via an RJ11 jack. The binding address which was approved by the laptop computer 6 is then input to the remote sensor 4 at step 15. The remote sensor 4 then determines if the binding address is a valid number at step 16. If it is not valid, the user returns to step 10 to get a valid number. On the other hand, if the binding address is valid then the user will enter a synchronize command which will store the binding address, at step 17, in permanent nonvolatile storage. If the synchronization command is determined to have been validly executed at step 18, then the binding address has been properly established and the laptop computer 6 can be disconnected from the remote sensor 4.

In the preferred embodiment the remote sensor 4 and the base transceiver 2 communicate with the laptop computer 6 via simple ASCII commands. These commands include binding, status, and various test functions for maintaining the remote sensor 4 and the base transceiver 2.

In the preceding examples, the communication protocols and binding techniques used by the invention were discussed in terms of its use in regard to control of an air conditioning system. For those skilled of the art will recognize that this invention can be used in conjunction with any type of sensor device. For example, they can be used in conjunction with humidity control system were an individual humidity sensors communicate with the base transceiver to control humidity throughout various locations of building; it can be used in conjunction with a security system in a building complex which will allow a central computer to control access to various parts of a building by workers; it can be used with a burglar alarm system; a fire alarm system; a flood detection system; or any other type of system which would require the use of remotely located sensors.

While the invention has been described with respect to a preferred embodiment thereof, it will be understood by those skilled in the art that various changes in detail may be made therein without departing from the spirit, scope, and teaching of the invention. For example, the number of channels and frequency spectrums used to communicate between the wireless thermostats and the base transceiver may vary, the RSSI and BSSI indicators and circuitry can be integrated with the wireless thermostats or implemented as a separate physical device to be used in conjunction with the thermostats, and the method of determining and assigning the binding number can vary so long as each wireless thermostat has a unique number. Likewise, the number of data items transferred between the wireless thermostat and the base transceiver can vary, etc. Accordingly, the invention herein disclosed is to be limited only as specified in the following claims.

I claim:

1. A sensor system, further comprising:
a base transceiver;
at least one sensor having means to communicate with the base transceiver, the sensor further having a unique identification code; and
means in the base transceiver to identify the sensor using the unique identification code, the base transceiver further communicating only with a sensor having a valid unique identification code;
whereby communications between the base transceiver and the sensor are enabled by a valid unique identification code.

2. A system, as in claim 1, further comprising:
means to bind a sensor to a transceiver, further comprising:
means to select a particular identification code for use by a single sensor from a set of available identification codes;
means to store the selected identification code in storage in the sensor;
means to store the selected identification code in the base transceiver;
means the compare the selected identification code in the sensor to the selected identification code in the base transceiver; and
means to authorize communication between the sensor when the selected identification code in the sensor matches the selected identification code in the base transceiver;
whereby only a base receiver and a sensor that have been bound together by a unique identification code can communicate with one another.

3. A system, as in claim 2, further comprising:
the means to select a particular identification code is a programmable device, the programmable device having means to input the selected identification code into the sensor storage, and further having means to input the selected identification code into the base transceiver.

4. A system, as in claim 3, wherein the programmable device is a computer.

5. A system, as in claim 3, wherein the programmable device is the base transceiver.

6. A system, as in claim 2, further comprising:
RSSI measurement means in the sensor;
BSSI measurement means in the sensor;
an indicator indicating the strength of the RSSI and/or BSSI measurements;
whereby the best location for the sensor is determined by using the highest value for the RSSI measurement and/or the lowest value for the BSSI measurement, and placing the sensor the location.

7. A system, as in claim 6, further wherein the RSSI and BSSI measurement values are used to create a single value that indicates the best location for the sensor.

8. A system, as in claim 6, wherein the RSSI and the BSSI are used independently to create values that indicate the best location for the sensor.

9. A system, as in claim 2, further comprising:
a plurality of sensor/base transceiver pairs, each sensor in each sensor/base transceiver pair having a retry time interval selected from a range of acceptable retry time intervals;
means to select a transmission frequency for sensor/base transceiver communications for each sensor/base transceiver pair;
means to determine when the selected transmission frequency is in use by another sensor/base transceiver pair; and
means to retry transmission after a preselected time interval;
whereby each sensor/base transceiver pair automatically retry's communication after a predetermined time interval when collisions occur during communications.

10. A system, as in claim 9, wherein the preselected time interval for each sensor/base transceiver pair varies from other sensor/base transceiver pairs;
whereby each sensor/base transceiver pair has a different retry time interval to avoid repetitive collisions when attempting to communicate.

11. A sensor system, further comprising:
a plurality of base transceivers;
a plurality of sensors, each sensor associated with, and having means to communicate with, one of the base transceivers;
each associated sensor/base transceiver pair sharing a unique identification code;
each base transceiver further communicating only with the sensor having the shared unique identification code;
each sensor/base transceiver pair further having means to select a communications frequency from a plurality of available transmission frequencies;
means in each sensor to periodically communicate with its associated base transceiver; and
each sensor/base transceiver pair further having means to detect when the selected communications frequency is unavailable and to automatically retry communications after a preselected time interval;
whereby communications between the base transceiver and the sensor are enabled by a valid unique identification code.

12. A system, as in claim 11, wherein the preselected time interval for each sensor/base transceiver pair varies from other sensor/base transceiver pairs;
whereby each sensor/base transceiver pair has a different retry time interval to avoid repetitive collisions when attempting to communicate.

13 A system, as in claim 11, further comprising:
RSSI measurement means;
BSSI measurement means;
an indicator indicating the strength of the RSSI and/or BSSI measurements;
whereby the best location for the sensor is determined by using the highest value for the RSSI measurement and/or the lowest value for the BSSI measurement, and placing the sensor the location.

14. A system, as in claim 13, further wherein the RSSI and BSSI measurement values are used to create a single value that indicates the best location for the sensor.

15. A system, as in claim 13, wherein the RSSI and the BSSI are used independently to create values that indicate the best location for the sensor.

16. A method of controlling communication between multiple sensor/base transceiver pairs, including the steps of cold
binding each sensor/base transceiver pair together by programming the sensor and the base transceiver with a unique binding code; and
transmitting the binding code as part of data transmission between the sensor/base transceiver pair such that the binding code is used to identify each member of the sensor/base transceiver pair to one another;
whereby the binding code allows multiple sensor/base transceiver pairs to communicate in close proximity to one another without interfering with communications from other sensor/base transceiver pairs.

17. A method, as in claim 16, including the additional steps of:
determining the RSSI value when the sensor is in a particular physical location;
displaying an indication of the RSSI value such that an indication of single strength for a particular physical location can be determined; and
moving the sensor in a physical location to determine where in that location the sensor receives a suitable single for a communications;
whereby a suitable physical location for installing a sensor can be determined based on determining single strength as indicated by the RSSI.

18. A method, as in claim 16, including the additional steps of:
determining the BSSI value when the sensor is in a particular physical location;
displaying an indication of the BSSI value such that an indication of single strength for a particular physical location can be determined; and
moving the sensor in a physical location to determine where in that location the sensor receives a suitable single for a communications;
whereby a suitable physical location for installing a sensor can be determined based on determining single strength as indicated by the BSSI.

19. A method, as in claim 16, including the additional steps of:
determining the RSSI value when the sensor is in a particular physical location;
determining the BSSI value when the sensor is in a particular physical location;
displaying an indication of the RSSI and BSSI values to indicate the perception/transmission characteristics for data communications in a particular physical location; and
moving the sensor to determine where the best location for data communications is;
whereby a suitable physical location for installing a sensor can be determined based on determining relative single strengths of RSSI and BSSI.

20. A method, as in claim 16, including the additional steps of:
using multiple sensor/base transceiver pairs to control data communications between plurality of locations;
using multiple frequency channels for simultaneous communication between multiple sensor/base transceiver pairs;
re-communicating data between the sensor/base transceiver pair in the event of a communications failure; and
using varying time periods for sensor/base transceiver pairs when data is re communicating between the sensor/base transceiver pair.
